(19) United States
(12) Patent Application Publication
(10) Pub. No.: US 2022/0398302 A1
(43) Pub. Date: Dec. 15, 2022

(54) SECURE WEARABLE LENS APPARATUS

(71) Applicant: Trivver, Inc., Merritt Island, FL (US)

(72) Inventor: Joel LaMontagne, Merritt Island, FL (US)

(21) Appl. No.: 17/344,551

(22) Filed: Jun. 10, 2021

(51) Int. Cl. G06F 21/32; G06F 1/16; G06F 16/29; G06K 9/00; G02B 27/01; G01S 19/42

(52) U.S. Cl. CPC G06F 21/32; G06F 1/163; G06F 16/29; G06K 9/00604; G06K 9/00013; G02B 27/0172; G01S 19/42

(57) ABSTRACT

Using various embodiments, systems and devices to access secure data using a wearable lens device are described. In one embodiment, the wearable lens device comprises at least one optical lens, a processing system, and, a display system, coupled to the processing system. The display system can be configured to present at least one of an augmented reality, virtual reality, and/or mixed reality artifact on the at least one optical lens. The augmented reality, virtual reality artifact, and/or mixed reality artifact can be related to secure data whose access is intended to be controlled and/or limited.

### FIELD OF THE INVENTION

Embodiments of the present invention relates generally to data security. More particularly, embodiments of the invention relate to providing mechanisms to view secure data using wearable lenses (e.g., glasses, spectacles, contact lenses, etc.).

### BACKGROUND OF THE INVENTION

Augmented Reality (AR) and Virtual Reality (VR) based glasses have existed in the commercial arena for some time now. In these systems a user can adorn the wearable lens device and view AR/VR or mixed reality artifacts.

However, such systems do not provide any data security and therefore potential misuse by authorized access of one's data is plausible. Therefore, what is needed are techniques, methods, systems, and apparatuses that can provide secure access to the data when viewed with wearable lens devices.

### SUMMARY OF THE DESCRIPTION

A Wearable Lens Device (WLD) comprising at least one optical lens, a processing system, and a display system, coupled to the processing system is disclosed. In one embodiment, the processing system of the WLD can be configured to present at least one of an augmented reality or virtual reality artifact on the at least one optical lens. The optical lens can be made of a transparent substance that is used to form an image of a real-world object by focusing rays of light from the object. The display system can include a micro-display panel and a waveguide comprising at least one grating layer. In one embodiment, the waveguide is formed by embedding the at least one grating layer between layers of the optical lens. The WLD can also include a biometric scanner. The biometric scanner can be configured to authenticate or identify the user. The biometric scanner can be a retinal scanner, iris scanner, eye vein verification system, an ocular-based biometric scanner, or a fingerprint scanner. In one embodiment, the biometric scanner can measure and/or records the distance between a user's eye and the WLD. Thereafter, secure data becomes available through the WLD upon successful authentication or identification of the user. In one embodiment, the display system allows overlaying of virtual objects onto the real world through the optical lens.

In one embodiment, the WLD can also include a Geo-Positioning System (GPS) transmitter, wherein the GPS transmitter is configured to periodically transmit the GPS coordinates of the WLD. The WLD can be configured to be operable only when the GPS coordinates of the WLD are within a predetermined geographical area. In this embodiment, the WLD is non-operative when the GPS coordinates of the WLD are not within a predetermined geographical area. Further, the WLD can be configured to become non-operable after a predetermined time period of not being within the predetermined geographical area.

In one embodiment, a system comprises a WLD and an authorization system, preferably wirelessly, coupled to the WLD. The authorization system can be configured to receive an at least one of an authentication or identification of a user and transmit secure data to the WLD. In one embodiment, the authorization server can be configured to receive Geo-Positioning System (GPS) coordinates of the WLD and the secure data is transmitted to the WLD only when the GPS coordinates are within a predetermined geographical area. In one embodiment, the secure data is not transmitted when the GPS coordinates are not within a predetermined geographical area. In yet another embodiment, the secure data is not transmitted after a predetermined time period of determining that the GPS coordinates are not within the predetermined geographical area.

### BRIEF DESCRIPTION OF THE DRAWINGS

The present invention is illustrated by way of example and not limitation in the figures of the accompanying drawings in which like references indicate similar elements.

FIG. 1 illustrates a WLD 100 according to one embodiment of the present invention.

FIG. 2 illustrates a block diagram of a system according to one embodiment of the present invention.

FIG. 3 illustrates a flow chart of an initial setup of WLD 100, according to one embodiment of the present invention.

FIG. 4 illustrates a flow chart of an initial setup of WLD 100 at an authorization server, according to one embodiment of the present invention.

FIG. 5 illustrates a flow chart of a user's access to secure data, according to one embodiment of the present invention.

FIG. 6 illustrates a flowchart of disabling a user's access of through WLD 100, according to one embodiment of the invention.

FIG. 7 is a block diagram illustrating a data processing system such as a computing system 1900 which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described can be performed in a different order. Moreover, some operations can be performed in parallel rather than sequentially.

A Wearable Lens Device (WLD), as described herein, includes AR, VR, and/or mixed reality technology enhanced user wearable glasses, spectacles, contact lenses, night vision goggles, or any other wearable lens which permits a user to see or view AR,VR, and/or mixed reality artifacts, which are optionally superimposed on the user's real world viewable perception (i.e., the real world viewed through the wearable glasses, spectacles, contact lenses, etc.). The WLD also refers to device(s) and/or apparatus(es) that permit the user to view real world imagery that is enhanced using augmented and/or virtual reality technology using wearable glasses, spectacles, contact lenses, or any other wearable lens. In one or more implementations the WLD can also include Global Positioning System (GPS) based transmitter and/or receiver which can assist to determine the location of the WLD. In one or more implementation, the WLD can also include or be coupled to a biometric scanning device (e.g., retinal scanner, iris scanner/recognition systems, eye vein verification, other ocular-based biometric scanner, fingerprint scanner, etc.) to authenticate/identify the user adorning the WLD. The WLD is also interchangeably referred to as Smart Glasses herein.

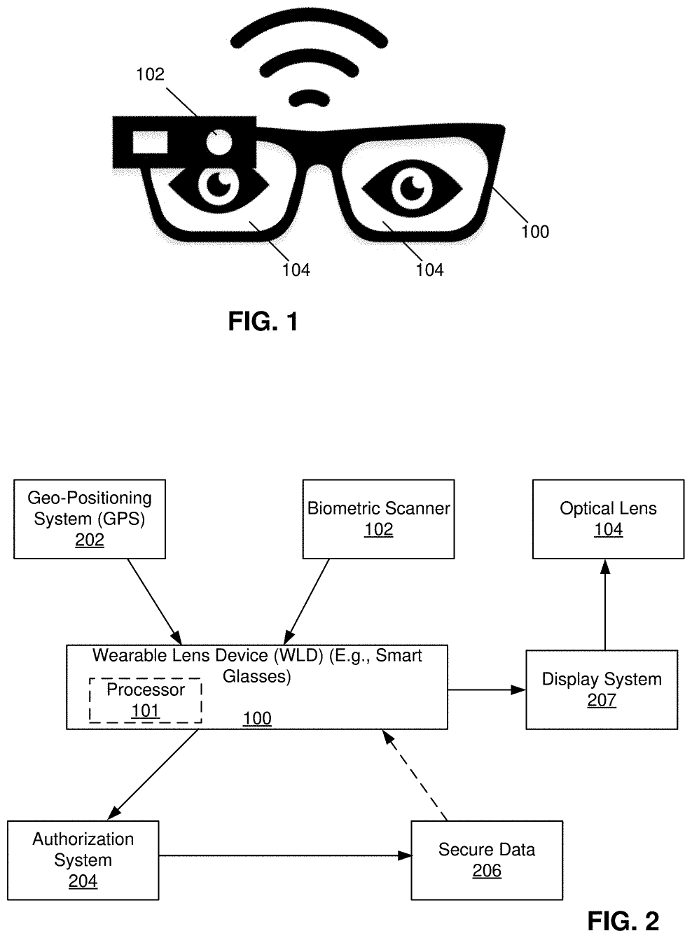

FIG. 1 illustrates a WLD 100 according to one embodiment of the present invention. As illustrated, in this embodiment, WLD 100 is depicted as glasses/spectacles. WLD 100 can also be equipped with networking capability (e.g., WiFi, Bluetooth, etc.) to enable WLD 100 to join a computer network. As illustrated WLD 100 has optical lens(es) 104 configured to receive at least one of an augmented reality or virtual reality artifact. In some implementations WLD 100 can comprise biometric scanner 102 to authenticate or identify the user of WLD 100. In one embodiment, upon successful authentication or identification of the user, secure data is available to the WLD to display to the user. The secure data can be received from a remote server or can also be presented locally within WLD 100. In some embodiments, biometric scanner 102 can be a retinal scanner, iris scanner, eye vein verification system, an ocular-based biometric scanner, or a fingerprint scanner. In one embodiment, biometric scanner 102 can be configured to measure and record the distance (or range) between a user's eye and the WLD 100 to identify the user.

FIG. 2 illustrates a block diagram of a system according to one embodiment of the present invention. As illustrated, in one embodiment, WLD 100 can include processor 101 to process information received or transmitted by WLD 100. In one embodiment, WLD 100 can also include Geo-Positioning System (GPS) transmitter 202 and is configured to periodically transmit the GPS coordinates of WLD 100. In some embodiments, WLD 100 is operative only when the GPS coordinates, as received from GPS transmitter 202, are within a predetermined geographical area and is non-operative when the GPS coordinates are not within a predetermined geographical area. In another embodiment, WLD 100 becomes non-operative after a predetermined time period of not being within the predetermined geographical area. In one embodiment, display system 207 can include a micro-display panel, a waveguide comprising at least one grating layer, wherein the waveguide is formed by embedding the at least one grating layer between the at least one optical lens 104. In some implementations, display system 207 allows overlaying of virtual objects onto the real world through the optical lens.

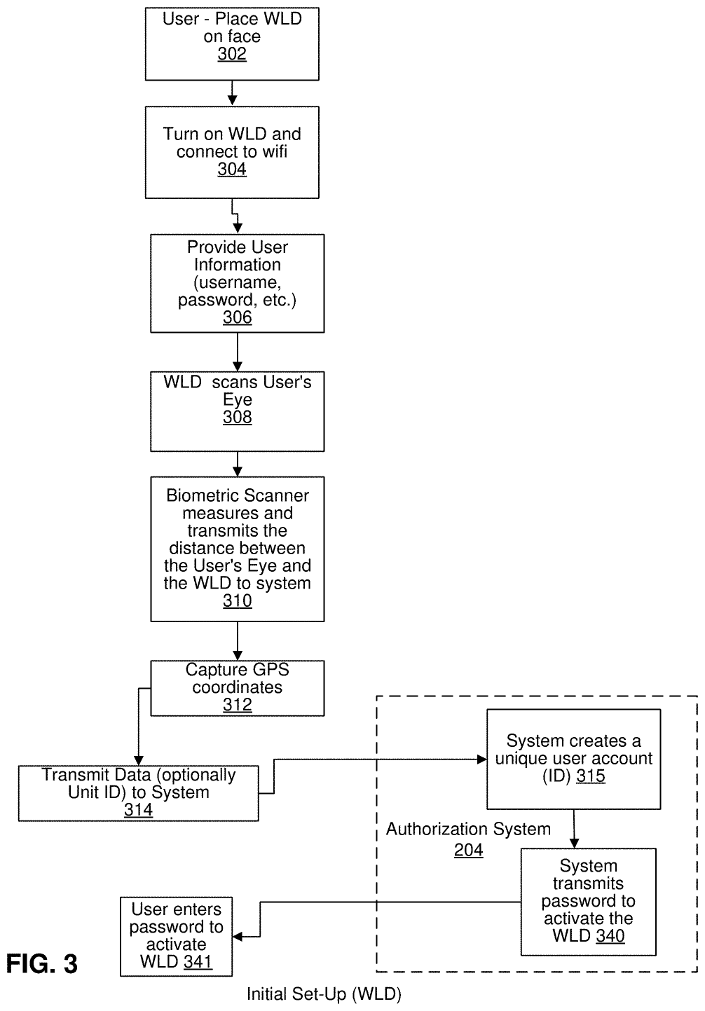

In one embodiment, WLD 100 processes the data received from biometric scanner 102 and/or GPS 202 transmits it to authentication system 204 for verification. Authorization system 204 can, in one or more embodiments, perform any of the functions as further described in FIGS. 3-6 and the corresponding disclosure herein. Once authorization system 204 determines whether access can be granted to WLD 100, secure data 206 is accessed and transmitted to WLD 100. In one embodiment, authorization system 204 permits transferring of secure data 206 to the WLD 100 when the GPS coordinates of WLD 100 are within a predetermined geographical area. In this embodiment, secure data 206 is not transmitted when the GPS coordinates are not within a predetermined geographical area. In another embodiment, secure data 206 is not transmitted after a predetermined time period of determining that the GPS coordinates of WLD 100 are not within the predetermined geographical area.

Secure data 206 can be stored in a database or memory store associated with authorization system 206. After secure data 206 is received, the information is transmitted to display system 207 from where it can be viewed/augmented on optional lens 104. In one embodiment, display system is embedded and/or included within WLD 100. In another embodiment, WLD 100 is coupled to display system 207.

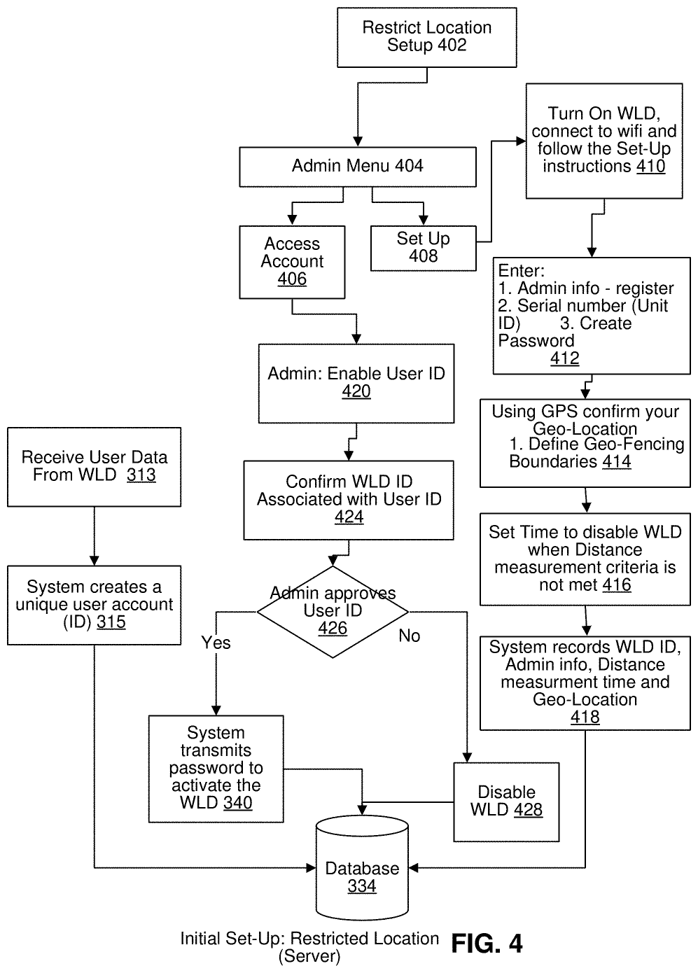

FIG. 3 illustrates a flow chart of an initial setup of WLD 100, according to one embodiment of the present invention. As illustrated, at 302 user places WLD 100 on their face. At 304, the WLD is turned on and connects to a computer network. In one embodiment, WLD 100 can connect to the computer network using any known wireless technology (e.g., WiFi, Bluetooth, etc.). At 306, the user is prompted to enter their information. This information can include a username and/or password. At 308, WLD 100 initiates biometric scanning to identify or authorize the user. If biometric scanning entails retinal scan, the eyes of the user are scanned using the biometric scanner. Optionally, at 310, the biometric scanner measures and transmits the distance between the user's eye and the WLD to authorization system 204. At 312, the current GPS location of WLD is recorded. At 314, the information captured/recorded at 306-312 is transmitted to authorization system 204. At 315, authorization system 204 creates a user account and associates the information received with a unique identifier to the user (User ID). At 340, the system transmits an initialization password to WLD 100 which can be entered by a user to activate WLD 100, as illustrated at 341. In one embodiment, the initialization password/passcode is transmitted remotely by authorization system 204, at 341, after user and device verification, as illustrated in FIG. 4 and its corresponding disclosure.

FIG. 4 illustrates a flow chart of an initial setup of WLD 100 at an authorization server, according to one embodiment of the present invention. In one embodiment, prior to the initial setup of WLD 100 as illustrated in FIG. 3, WLD is set-up at authorization server 204. As illustrated, at 402 a location based restriction is setup from admin (administrator) menu 404 and setup initialization at 408 by an administrator of authorization system 204. In this embodiment, WLD 100 is configured by setting up wireless access to a computer network at 410. At 412, the administrative information of WLD 100 is setup. At 414, the GPS location of WLD 100 is used to determine the geographical location where secure access of WLD 100 would be needed. A Geo-fencing parameter is defined where restricted/secure access needs to be provided. Optionally, at 416, a predetermined time period can be configured after which the operation of WLD 100 is disabled if WLD 100 is outside the geo-fencing parameter. At 418, authorization system 204 records the information gathered at 412-416 and saves the information in database 334, associating the record with a unique WLD device ID (Unit ID).

At 313, once authorization system 204 receives the user registration data (as illustrated in FIG. 3), and at 315, authorization system 204 creates a user account, user registration data is stored in database 334 for authorization/access to the WLD being registered by the user. To do so, at 406, the administrator, through admin menu 404, can select account access and at 420, select an option to enable user ID. At 424, in one embodiment, the administrator can, after verification, confirm that WLD ID associated with WLD 100 is to be assigned to the user who set up an account using WLD 100 (as illustrated in FIG. 3). At 426, the administrator approves the user ID to be associated with WLD 100. It should be noted, the administrator can approve and assign multiple users with WLD 100 (the same device). If the administrator approves the user ID, as illustrated at 340, system 204 transmits a password to the user to activate WLD. If the administrator does not approve the user, the WLD is disabled, at 428. At 334, the user's approval status is updated in database 334.

In one embodiment, the WLD configuration, as illustrated at 414-418, can be configured and customized for each user. In other words, multiple users can be assigned to the same WLD, and depending on the user, the access parameters/configuration, illustrated at 414-418, can be adjusted accordingly. Thus, authorization system 204 will permit WLD 100 to access a different set of secure data 206, with different configuration parameters depending on the user wearing the device.

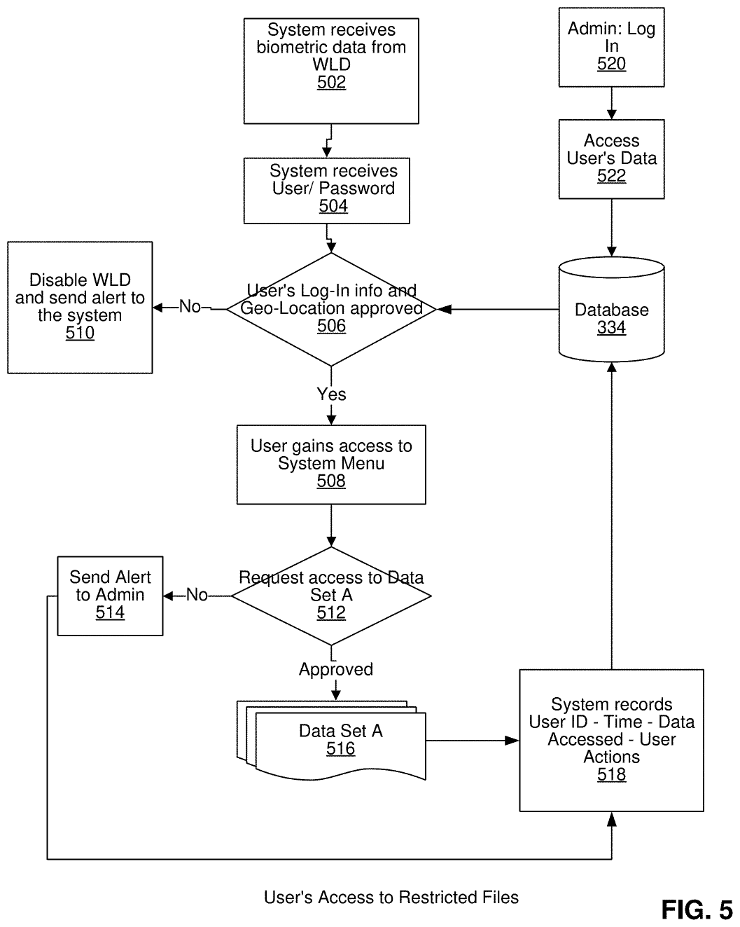

FIG. 5 illustrates a flow chart of a user's access to secure data, according to one embodiment of the present invention. As illustrated, at 502, system 204 received biometric data from WLD 100. At 504, the system can also, optionally, receive a username password from the user of WLD 100. At 506, system 204 determines whether the user's credentials, that is, login information, biometric information, geo-location from where access is requested, or a combination thereof, are approved. If not, at 510, WLD 100 is disabled and, optionally, an alert is transmitted to the administrator. In one embodiment, at 510, WLD 100 enables a recording mode/capture mode using a camera embedded into WLD 100 in an attempt to capture the face of the user of WLD 100 that caused WLD 100 to be disabled. In this embodiment, the camera can either be a part of the biometric scanner 102 or a separate camera (not shown) embedded in WLD 100. In one embodiment, the separate camera can be a stealth camera that is not visible to the user. The recording mode can be set to a predetermined period of time (e.g., 30 seconds, 1 minutes, 5 minutes, etc.). In this embodiment, prior to disabling WLD 100, the data captured so far (that is, login information, biometric information, geo-location from where access is requested, etc.) and the information captured while the recording mode is enabled is transmitted to system 204. Thereafter, WLD is disabled at 510 and rendered inoperative.

If however, access is granted, at 508, the user gains access to a system menu from where access to secure data 206 can be requested. At 512, the user requests access to secure data 206 (set A). If the user is permitted to access secure data 206, at 516, the data is transmitted to WLD 100. Optionally, if however, the user's is not authorized to request secure data 206 (Set A) at 514, an alert can be transmitted to the administrator about the attempted unauthorized access of secure data 206. At 518, the system records and maintains a log of the files accessed or requested by the user.

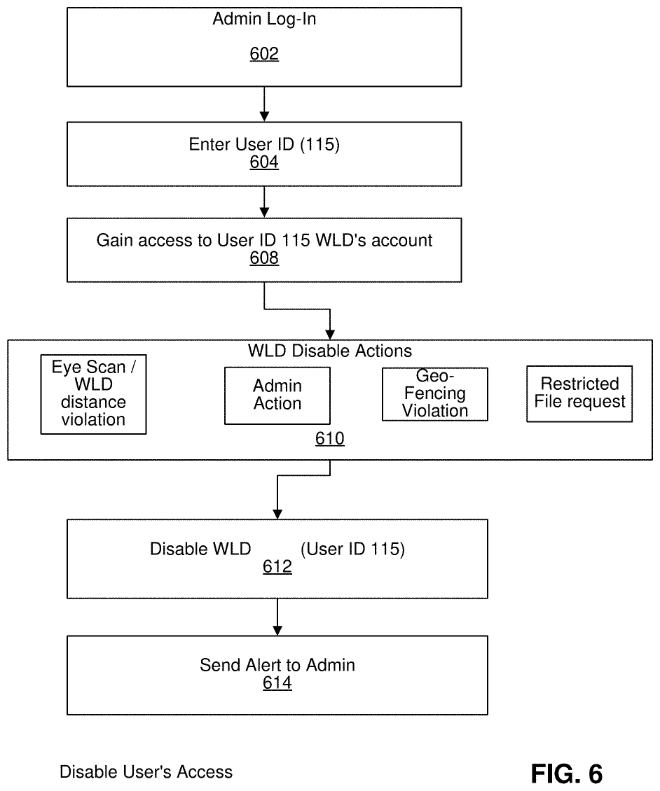

FIG. 6 illustrates a flowchart of disabling a user's access of through WLD 100, according to one embodiment of the invention. As illustrated, at 602, an administrator logs into authorization system 204. At 604, a user's ID (e.g., 115), name, username, or other identification information can be entered. At 608, access to the user's profile is granted to the administrator. At 610 the administrator is provided options to disable/restrict access to secure data 206 through WLD 100. At 612, user's access to WLD 100 is disabled. At 614, optionally, an alert can be sent to the administrator. In an alternative embodiment, system 204 can be configured to automatically disable a user's access if a violation is determined to occur a predetermined number of times. For example, authorization system 204 can be configured to disable a user's access to WLD 100 if one of the conditions described in 610 occur a number of times (e.g., two, three, four times). Once WLD is disabled pertinent information (e.g., WLD location, user information, including biometric data, etc.) can be recorded in database 334.

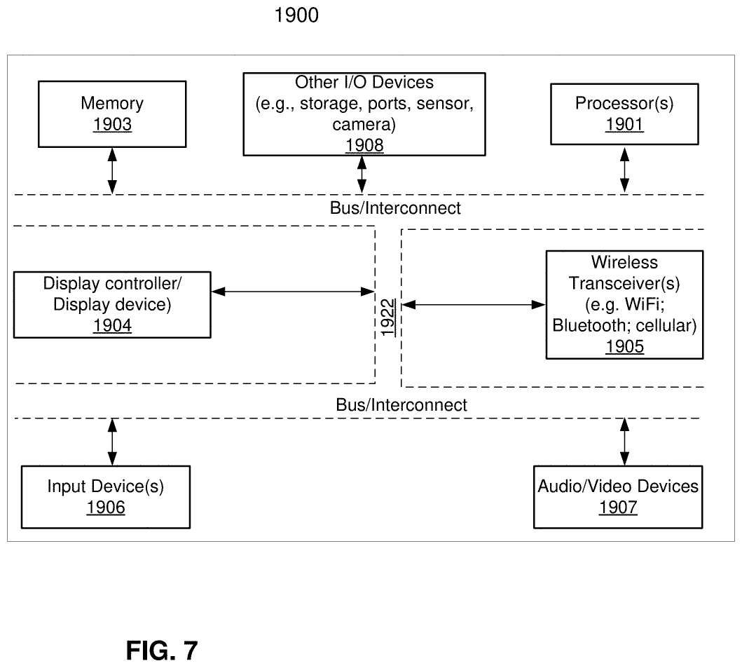

FIG. 7 is a block diagram illustrating a data processing system such as a computing system 1900 which may be used with one embodiment of the invention. For example, system 1900 can be implemented as part of WLD 100, Authorization system 204, data store serving secure data 206, and/or database 334. It should be apparent from this description that aspects of the present invention can be embodied, at least in part, in software. That is, the techniques may be carried out in a computer system or other computer system in response to its processor, such as a microprocessor, executing sequences of instructions contained in memory, such as a ROM, DRAM, mass storage, or a remote storage device. In various embodiments, hardware circuitry may be used in combination with software instructions to implement the present invention. Thus, the techniques are not limited to any specific combination of hardware circuitry and software nor to any particular source for the instructions executed by the computer system. In addition, throughout this description, various functions and operations are described as being performed by or caused by software code to simplify description. However, those skilled in the art will recognize what is meant by such expressions is that the functions result from execution of the code by a processor.

System 1900 can have a distributed architecture having a plurality of nodes coupled through a network, or all of its components may be integrated into a single unit. Computing system 1900 can represent any of the data processing systems described above performing any of the processes or methods described above. In one embodiment, computer system 1900 can be implemented as integrated circuits (ICs), discrete electronic devices, modules adapted to a circuit board such as a motherboard, an add-in card of the computer system, and/or as components that can be incorporated within a chassis/case of any computing device. System 1900 is intended to show a high level view of many components of any data processing unit or computer system. However, it is to be understood that additional or fewer components may be present in certain implementations and furthermore, different arrangement of the components shown may occur in other implementations. System 1900 can represent a desktop, a laptop, a tablet, a server, a mobile phone, a programmable logic controller, a personal digital assistant (PDA), a personal communicator, a network router or hub, a wireless access point (AP) or repeater, a set-top box, or a combination thereof.

In one embodiment, system 1900 includes processor 1901, memory 1903, and devices 1905-1908 via a bus or an interconnect 1922. Processor 1901 can represent a single processor or multiple processors with a single processor core or multiple processor cores included therein. Processor 1901 can represent one or more general-purpose processors such as a microprocessor, a central processing unit (CPU), Micro Controller Unit (MCU), etc. Processor 1901 can be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 1901 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 1901, can also be a low power multi-core processor socket such as an ultra low voltage processor, may act as a main processing unit and central hub for communication with the various components of the system. Such processor can be implemented as a system on chip (SoC).

Processor 1901 is configured to execute instructions for performing the operations and methods discussed herein. System 1900 further includes a graphics interface that communicates with graphics subsystem 1904, which may include a display controller and/or a display device. Processor 1901 can communicate with memory 1903, which in an embodiment can be implemented via multiple memory devices to provide for a given amount of system memory. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector. Memory 1903 can be a machine readable non-transitory storage medium such as one or more volatile storage (or memory) devices such as random access memory (RAM), dynamic RAM (DRAM), synchronous DRAM (SDRAM), static RAM (SRAM), or other types of storage devices such as hard drives and flash memory. Memory 1903 may store information including sequences of executable program instructions that are executed by processor 1901, or any other device. System 1900 can further include IO devices such as devices 1905-1908, including wireless transceiver(s) 1905, input device(s) 1906, audio IO device(s) 1907, and other IO devices 1908.

Wireless transceiver 1905 can be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, network interfaces (e.g., Ethernet interfaces) or a combination thereof. Input device(s) 1906 can include a mouse, a touch pad, a touch sensitive screen (which may be integrated with display device 1904), a pointer device such as a stylus, and/or a keyboard (e.g., physical keyboard or a virtual keyboard displayed as part of a touch sensitive screen). Other optional devices 1908 can include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional devices 1908 can further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors can be coupled to interconnect 1922 via a sensor hub (not shown), while other devices such as a keyboard or thermal sensor may be controlled by an embedded controller (not shown), dependent upon the specific configuration or design of system 1900.

To provide for persistent storage of information such as data, applications, one or more operating systems and so forth, in one embodiment, a mass storage (not shown) may also couple to processor 1901. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on RE-initiation of system activities. Also a flash device may be coupled to processor 1901, e.g., via a serial peripheral interface (SPI). This flash device may provide for non-volatile storage of system software, including a basic input/output software (BIOS) as well as other firmware of the system.

Note that while system 1900 is illustrated with various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A Wearable Lens Device (WLD) comprising:
at least one optical lens;
a processing system; and
a display system, coupled to the processing system, configured to present at least one of an augmented reality, virtual reality, or mixed reality artifact on the at least one optical lens.

2. The WLD of claim 1, wherein the display system comprises:
a micro-display panel;
a waveguide comprising at least one grating layer, wherein the waveguide is formed by embedding the at least one grating layer between the at least one optical lens.

3. The WLD of claim 1, further comprising:
a biometric scanner, wherein the biometric scanner provides at least one of authentication or identification of the user.

4. The WLD of claim 3, wherein the biometric scanner is at least one of a retinal scanner, iris scanner, eye vein verification system, an ocular-based biometric scanner, or a fingerprint scanner.

5. The WLD of claim 3, wherein the biometric scanner measures and records the distance between a user's eye and the WLD.

6. The WLD of claim 3, wherein data becomes available through the WLD upon successful authentication or identification of the user.

7. The WLD of claim 1, further comprising:
a Geo-Positioning System (GPS) transmitter, wherein the GPS transmitter is configured to periodically transmit the GPS coordinates of the WLD.

8. The WLD of claim 7, wherein the WLD is operative only when the GPS coordinates are within a predetermined geographical area.

9. The WLD of claim 7, wherein the WLD is non-operative when the GPS coordinates are not within a predetermined geographical area and wherein the WLD becomes non-operative after a predetermined time period of not being within the predetermined geographical area.

10. The WLD of claim 1, wherein the display system allows overlaying of virtual objects onto the real world through the optical lens.

11. A system comprising:
a Wearable Lens Device (WLD); and
a computing device coupled to the WLD, the computing device configured to:
receive an at least one of an authentication or identification of a user,
transmit secure data to the WLD.

12. The system of claim 11, wherein the WLD comprises:
at least one optical lens;
a processing system; and
a display system, coupled to the processing system, configured to present at least one of an augmented reality, virtual reality, or mixed reality artifact on the at least one optical lens.

13. The system of claim 12, wherein the display system comprises:
a micro-display panel;
a waveguide comprising at least one grating layer, wherein the waveguide is formed by embedding the at least one grating layer between the at least one optical lens.

14. The system of claim 11, wherein the WLD comprises:
a biometric scanner, wherein the biometric scanner provides at least one of authentication or identification of the user.

15. The system of claim 14, wherein the biometric scanner is at least one of a retinal scanner, iris scanner, eye vein verification system, an ocular-based biometric scanner, or a fingerprint scanner.

16. The system of claim 14, wherein the biometric scanner measures and records the distance between a user's eye and the WLD.

17. The system of claim 11, wherein the computing device is further configured to:
receive Geo-Positioning System (GPS) coordinates of the WLD.

18. The system of claim 17, wherein the secure data is transmitted to the WLD only when the GPS coordinates are within a predetermined geographical area.

19. The system of claim 17, wherein the secure data is not transmitted when the GPS coordinates are not within a predetermined geographical area.

20. The system of claim 19, wherein the secure data is not transmitted after a predetermined time period of determining that the GPS coordinates are not within the predetermined geographical area.
